(19) United States
(12) Patent Application Publication
(10) Pub. No.: US 2008/0239565 A1
(43) Pub. Date: Oct. 2, 2008

(54) SERVO PATTERN RECORDING DEVICE

(75) Inventors: Osamu INOUE, Tokyo (JP); Keiji TESHIMA, Tokyo (JP); Koji MATSUNO, Tokyo (JP); Takashi HANDA, Tokyo (JP); Kazutaka FUJITA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/052,845

(22) Filed: Mar. 21, 2008

(30) Foreign Application Priority Data
Mar. 27, 2007 (JP) 2007-081985

(51) Int. Cl. G11B 5/33

(52) U.S. Cl. 360/110

(57) ABSTRACT

A servo pattern recording device capable of improving the recording accuracy of a servo pattern. The servo pattern recording device is comprised of a magnetic head that records a servo pattern for tracking servo on a magnetic tape, a first motor that feeds the magnetic tape, a second motor that takes up the magnetic tape, and a main panel along a surface of which the magnetic tape is caused to move. The first motor and the second motor are mounted on the main panel, and the magnetic head is mounted on a first sub panel that is formed separately from the main panel and is connected to the main panel via a connecting member.

### BACKGROUND OF THE INVENTION

1. Field of the Invention

The present invention relates to a servo pattern recording device that records a servo pattern for tracking servo on a magnetic tape.

2. Description of the Related Art

As a servo pattern recording device of this kind, there is known a servo writer disclosed in Japanese Laid-Open Patent Publication (Kokai) No. 2005-92938. This servo writer is comprised of a feed reel for feeding a magnetic tape, a take-up reel for taking up the magnetic tape, a servo signal write head for writing a servo signal (servo pattern) for tracking servo on the magnetic tape, and so forth. In this case, the servo signal write head is removably mounted on a head base member fixed on a panel side (panel). This makes it possible to replace the servo signal write head relatively easily.

### SUMMARY OF THE INVENTION

From the study of the above-described servo writer, the present inventors found out the following problems. In general, a servo writer of this kind, such as the aforementioned servo writer, is configured such that a motor for rotating the feed reel, and a motor for rotating the take-up reel are fixed on the panel side. On the other hand, the above-described magnetic tape is used for backup of a large amount of data. In this case, data are recorded on a large number of tracks on the magnetic tape. In recent years, in a recording medium using the magnetic tape of the above-mentioned kind, the number of tracks is increased to increase recording capacity, and along with the increase in the number of tracks, a recording and reproducing device, which records data on a recording medium and reproduces the recorded data, is required to use a servo pattern recorded in advance on the magnetic tape for the sake of more accurate control of tracking of a recording and reproducing head (motion of the recording and reproducing head in the direction of the width of the magnetic tape). To this end, in manufacturing the magnetic tape for use in the above-described recording medium, it is necessary to improve recording accuracy so as to record the servo pattern straight in the direction of the length of the magnetic tape. In the conventional servo writer, however, since the motors are fixed on the panel side together with the servo signal write head as described above, there is a risk of the vibrations of the motors being transmitted to the servo signal write head, which makes it difficult to improve recording accuracy.

The present invention was made in view of these problems, and a main object of the present invention is to provide a servo pattern recording device which is capable of improving recording accuracy of a servo pattern.

To attain the above main object, a servo pattern recording device according to the present invention comprises a magnetic head that records a servo pattern for tracking servo on a magnetic tape, a first motor that feeds the magnetic tape, a second motor that takes up the magnetic tape, and a main panel along a surface of which the magnetic tape is caused to move, wherein the first motor and the second motor are mounted on the main panel, and wherein the magnetic head is mounted on a first sub panel that is formed separately from the main panel and is connected to the main panel via a connecting member.

According to the servo pattern recording device according to the present invention, the first motor and the second motor are mounted on the main panel, and the magnetic head is mounted on the first sub panel that is formed separately from the main panel and is connected to the main panel via the connecting member, so that it is possible to reliably reduce transmission of vibration caused by the first and second motors to the magnetic head. Therefore, compared with the conventional servo writer which has the motors and the magnetic head mounted on a main panel thereof, it is possible to sufficiently improve the recording accuracy of the servo pattern.

In this case, it is possible to form a first opening in which the first sub panel can be fitted in the main panel, and connect the first sub panel to the main panel in a state in which the first sub panel is fitted in the first opening such that the surface of the main panel and a surface of the first sub panel are flush with each other. With this configuration, since no step is formed between the main panel and the first sub panel, it is possible to prevent a step from moving the magnetic tape in the direction of the width of the tape, thereby reliably preventing recording accuracy of the servo pattern from being degraded.

Further, it is possible to connect the first sub panel to the main panel with a vibration isolator interposed between the first sub panel and the main panel. With this configuration, it is possible to more reliably reduce transmission of vibration caused by the first and second motors to the magnetic head. This makes it possible to further improve the recording accuracy of the servo pattern.

Further, it is possible to mount a tape guide that guides the magnetic tape to the magnetic head, on the first sub panel. With this configuration, it is possible to reliably reduce transmission of vibration caused by the first and second motors to the tape guide. Therefore, compared with a construction in which the tape guide is mounted on the main panel, it is possible to further improve the recording accuracy of the servo pattern.

Further, the servo pattern may comprise a capstan motor that controls a traveling speed of the magnetic tape, and the capstan motor can be mounted on a second sub panel that is formed separately from the main panel and is connected to the main panel via a connecting member. With this configuration, it is possible to reliably reduce transmission of vibration caused by the capstan motor to the magnetic head. Therefore, compared with a construction in which the capstan motor is mounted on the main panel, it is possible to further improve the recording accuracy of the servo pattern.

Further, it is possible to form a second opening in which the second sub panel can be fitted, in the main panel, and connect the second sub panel to the main panel in a state in which the second sub panel is fitted in the second opening such that the surface of the main panel and a surface of the second sub panel are flush with each other. With this configuration, since no step is formed between the main panel and the second sub panel, it is possible to prevent a step from moving the magnetic tape in the direction of the width of the tape, thereby reliably preventing the recording accuracy of the servo pattern from being degraded.

Further, it is possible to connect the second sub panel to the main panel with a vibration isolator interposed between the second sub panel and the main panel. With this configuration, it is possible to more reliably reduce transmission of vibration caused by the capstan motor to the magnetic head, thereby making it possible further improve the recording accuracy of the servo pattern.

It should be noted that the present disclosure relates to the subject matter included in Japanese Patent Application No. 2007-081985 filed Mar. 27, 2007, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a block diagram showing the configuration of a servo writer;

FIG. 2 is an arrangement diagram showing the arrangement of a recording section;

FIG. 3 is a arrangement diagram showing the arrangement of a magnetic tape;

FIG. 4 is a plan view of a main panel;

FIG. 5 is a cross-sectional view taken on line A-A of FIG. 2;

FIG. 6 is a cross-sectional view taken on line B-B of FIG. 2;

FIG. 7 is a plan view showing the arrangement of another servo writer;

FIG. 8 is a plan view showing the arrangement of still another servo writer;

FIG. 9 is a diagram of results of experiments, which is useful for explaining the servo writers and a conventional servo writer.; and

FIG. 10 is a cross-sectional view of another main panel and a first sub panel in a connected state.

### DESCRIPTION OF THE PREFERRED EMBODIMENTS

Hereinafter, the best mode of a servo pattern recording device according to the present invention will be described with reference to the accompanying drawings.

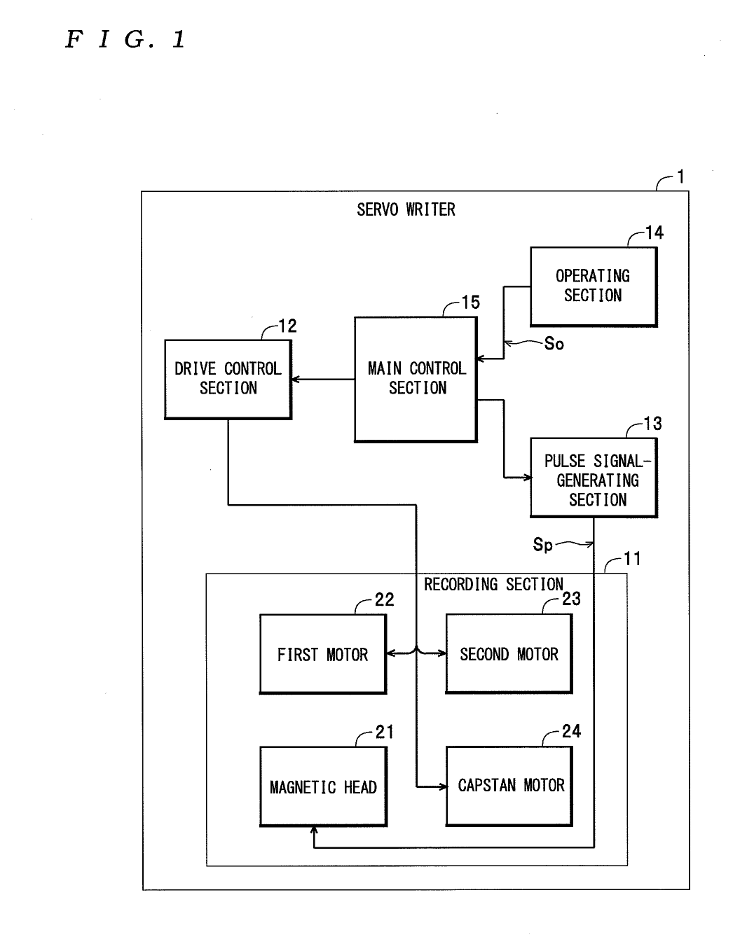

First, a description will be given of the construction of a servo writer 1. The servo writer 1 shown in FIG. 1 is an example of the servo pattern recording device according to the present invention. The servo writer 1 is comprised of a recording section 11, a drive control section 12, a pulse signal-generating section 13, an operating section 14, and a main control section 15, and is configured such that it can record a servo pattern Ps appearing in FIG. 3, on a magnetic tape 300 shown in FIG. 3. Here, the servo pattern Ps is for use in tracking servo used for controlling the tracking of a recording and reproducing head of a recording and reproducing device, not shown, which records data on the magnetic tape 300 and reproduces the recorded data. As shown in FIG. 3, the servo pattern Ps is recorded e.g., in a total of five servo bands 302 at opposite ends of the magnetic tape 300 in the direction of the width thereof and between four data bands 301 on the magnetic tape 300. It should be noted that each data band 301 is comprised of a plurality of (e.g., 176) data tracks.

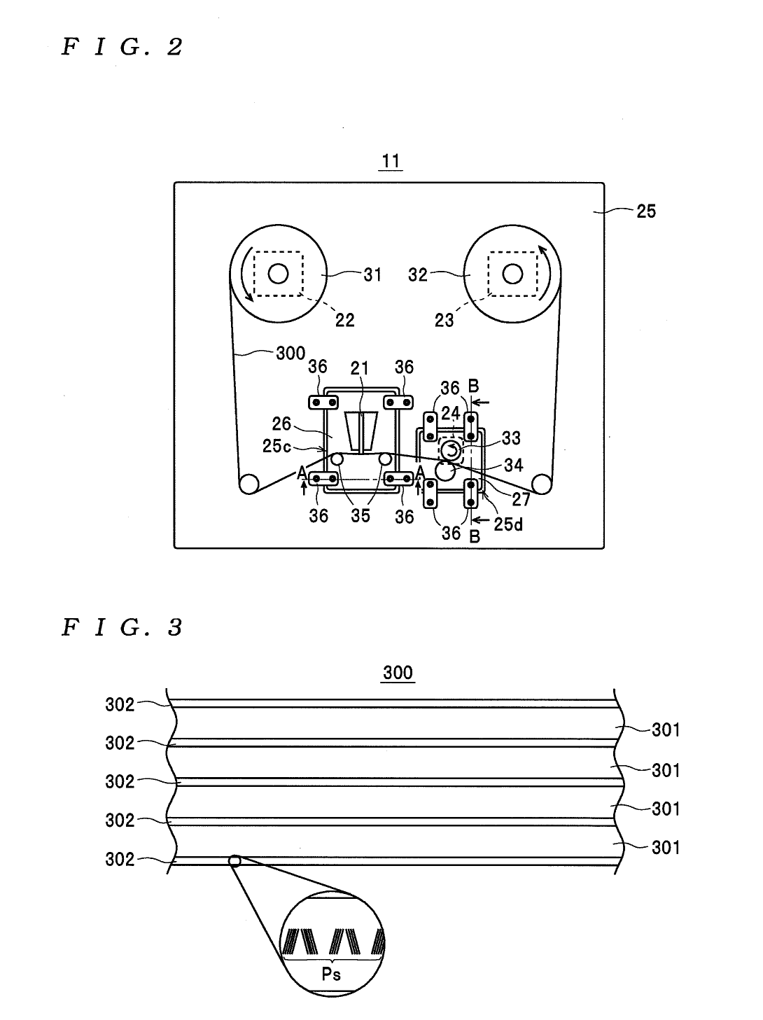

Referring to FIGS. 1 and 2, the recording section 11 is comprised of a magnetic head 21, a first motor 22, a second motor 23, a capstan motor 24, a main panel 25, a first sub panel 26, and a second sub panel 27. As shown in FIGS. 2 and 5, the magnetic head 21 is mounted on a front surface 26a of the first sub panel 26. Further, the magnetic head 21 records (writes) a servo pattern on the magnetic tape 300 in accordance with a pulse signal Sp delivered from the pulse signal-generating section 13. The first motor 22 operates under the control of the drive control section 12, and rotates a tape feed reel 31 (see FIG. 2) to thereby feed the magnetic tape 300. The second motor 23 operates under the control of the drive control section 12, and rotates a tape take-up reel 32 (see FIG. 2) to thereby take up the magnetic tape 300. In this case, the first motor 22 and the second motor 23 are mounted on a rear surface 25b (surface on the rear side of the sheet of FIG. 2) of the main panel 25.

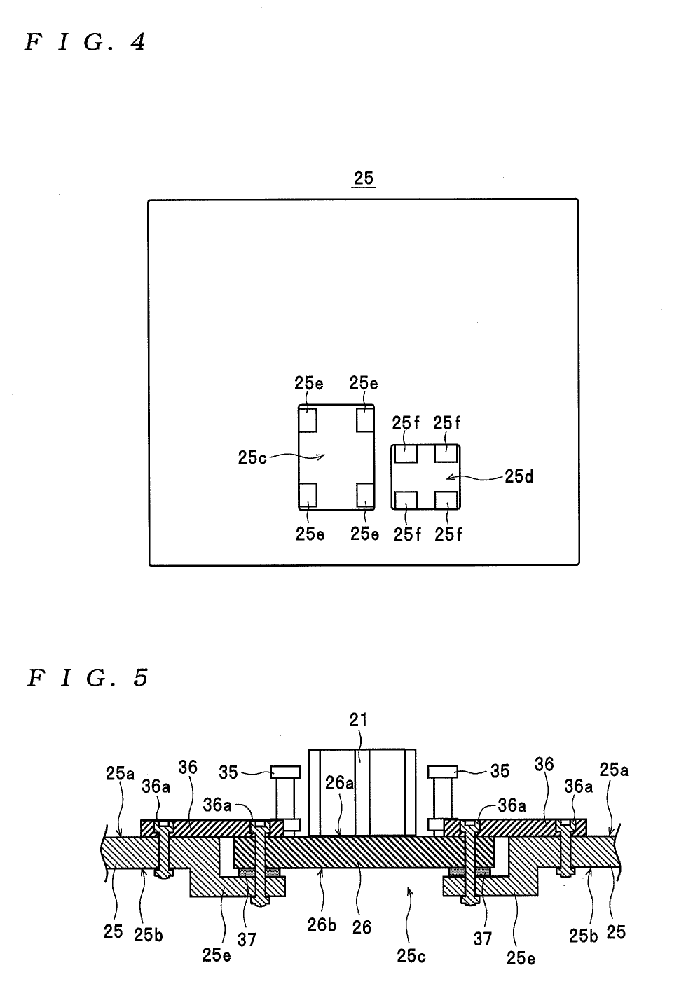

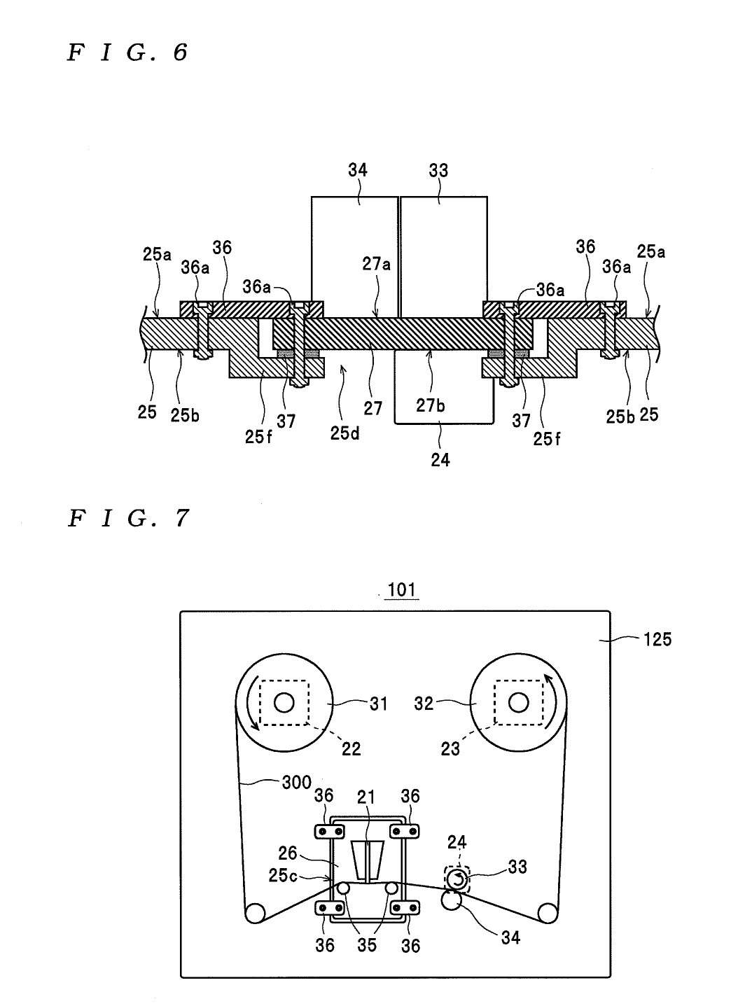

As shown in FIG. 6, the capstan motor 24 is mounted on a rear surface 27b of the second sub panel 27. Further, the capstan motor 24 operates under the control of the drive control section 12, and rotates a capstan 33 at a predetermined rotational speed to thereby move the magnetic tape 300 (see FIG. 2) sandwiched between the capstan 33 and a pinch roller 34 at a predetermined speed (i.e., control the traveling speed of the magnetic tape 300). The main panel 25 is in the form of a rectangular plate, and is configured such that the first motor 22 and the second motor 23 can be mounted thereon, e.g., as shown in FIG. 4. Further, the main panel 25 is formed with a first opening 25c in which the first sub panel 26 can be fitted, and a second opening 25d in which the second sub panel 27 can be fitted. Further, as shown in FIGS. 4 to 6, support portions 25e for supporting the first sub panel 26 are formed at an edge of the first opening 25c on the rear surface 25b side of the main panel 25, while support portions 25f for supporting the second sub panel 27 are formed at an edge of the second opening 25d on the rear surface 25b side of the main panel 25. In this case, as shown in FIG. 2, the magnetic tape 300 is moved along a front surface 25a of the main panel 25.

The first sub panel 26 is in the form of a rectangular plate. Further, as shown in FIG. 5, the first sub panel 26 is connected to the main panel 25 by connecting members 36 and fixing bolts 36a (via the connecting member 36) in a state in which the first sub panel 26 is fitted in the first opening 25c such that the front surface 26a thereof and the front surface 25a of the main panel 25 are flush with each other (an example of the front surfaces being approximately flush or flush with each other), and at the same time a gap is formed between the first sub panel 26 and the main panel 25. In this case, a vibration isolator 37 made of an elastic member (e.g., a rubber plate member) is interposed between the rear surface 26b of the first sub panel 26 and each support portion 25e of the main panel 25. Further, mounted on the front surface 26a of the first sub panel 26 are (a pair of) tape guides 35 for guiding the magnetic tape 300 to the magnetic head 21.

To record the servo pattern Ps on the magnetic tape 300 with high accuracy, it is necessary to smooth the surface of an object on which magnetic head 21 is to be mounted with high accuracy so as to make the level and orientation of the magnetic head 21 as prescribed (designed). In this case, in the conventional servo writer, the size of the main panel on which the magnetic head 21 is mounted is large, which makes it very difficult to smooth the whole front surface of the main panel with high accuracy. In contrast, in the servo writer 1, the size of the first sub panel 26 on which the magnetic head 21 is mounted is small, and hence it is relatively easy to smooth the whole front surface 26a of the first sub panel 26 with high accuracy.

The second sub panel 27 is in the form of a rectangular plate. Further, as shown in FIG. 6, the second sub panel 27 is connected to the main panel 25 by the connecting members 36 and the fixing bolts 36a (via the connecting members 36) in a state in which the second sub panel 27 is fitted in the second opening 25d such that the front surface 27a thereof and the front surface 25a of the main panel 25 are flush with each other (an example of the front surfaces being approximately flush or flush with each other), and at the same time a gap is formed between the second sub panel 27 and the main panel 25. In this case, the above-mentioned vibration isolator 37 is interposed between the rear surface 27b of the second sub panel 27 and each support portion 25f of the main panel 25. Further, the capstan 33 and the pinch roller 34 are rotatably mounted on the front surface 27a of the second sub panel 27.

The drive control section 12 controls the first motor 22, the second motor 23, and the capstan motor 24 under the control of the main control section 15. The pulse signal-generating section 13 delivers the pulse signal Sp to the magnetic head 21 of the recording section 11 under the control of the main control section 15. The operating section 14 is comprised of various switches and keys, and delivers operation signals So in accordance with the operations of the switches and keys. The main control section 15 controls the drive control section 12 and the pulse signal-generating section 13 in accordance with the operation signals So delivered from the operating section 14.

Next, a description will be given of the operations of the respective sections of the servo writer 1, performed when the servo pattern Ps is recorded on the magnetic tape 300 using the servo writer 1.

First, recording conditions, such as the traveling speed (tape speed) of the magnetic tape 300, the pitch of the servo pattern Ps, and so forth, are set by operating the operating section 14, and then the start of recording is instructed. Next, the main control section 15 causes the drive control section 12 to start control of the first motor 22, the second motor 23, and the capstan motor 24 of the recording section 11 in accordance with the operation signals So delivered from the operating section 14. In doing this, the drive control section 12 causes the capstan motor 24 to move the magnetic tape 300 at the set tape speed, while causing the first motor 22 and the second motor 23 to feed and take up the magnetic tape 300. Subsequently, the main control section 15 causes the pulse signal-generating section 13 to start delivery of the pulse signal Sp. Next, the magnetic head 21 of the recording section 11 records (writes) the servo pattern Ps on the magnetic tape 300 in accordance with the pulse signal Sp, whereafter the main control section 15 causes the pulse signal-generating section 13 to stop the delivery of the pulse signal Sp when the magnetic tape 300 is moved by a predetermined length (when a predetermined time period has elapsed from the start of the recording). Further, the main control section 15 controls the first motor 22, the second motor 23, and the capstan motor 24 via the drive control section 12 to thereby cause them to stop the feed, take-up, and travel of the magnetic tape 300. This terminates the recording of the servo pattern Ps on the magnetic tape 300.

In this case, in the servo writer 1, the first motor 22 and the second motor 23 are mounted on the main panel 25, and the magnetic head 21 is mounted on the first sub panel 26 which is formed separately from the main panel 25 and is connected to the main panel 25 via the connecting members 36, so that transmission of vibration of the motors 22 and 23 to the magnetic head 21 is reliably reduced. Further, since the capstan motor 24 is mounted on the second sub panel 27 which is formed separately from the main panel 25 and is connected to the main panel 25 via the connecting members 36, transmission of vibration of the capstan motor 24 to the magnetic head 21 is reliably reduced. Therefore, compared with the conventional servo writer which has the motors and the magnetic head 21 mounted on the main panel 25, it is possible to sufficiently improve the recording accuracy of the servo pattern Ps.

Further, in the servo writer 1, the first sub panel 26 is connected to the main panel 25 in a manner such that the front surface 26a thereof is flush with the front surface 25a of the main panel 25. That is, the servo writer 1 is configured such that no step is formed between the main panel 25 and the first sub panel 26. This prevents a step from moving the magnetic tape 300 in the direction of the width of the tape, thereby reliably preventing the recording accuracy of the servo pattern Ps from being degraded. Further, in the servo writer 1, the vibration isolators 37 are interposed between the first sub panel 26 and the main panel 25 and between the second sub panel 27 and the main panel 25. This makes it possible to more reliably reduce transmission of vibration caused by the first motor 22, the second motor 23, and the capstan motor 24, to the magnetic head 21. Furthermore, in the servo writer 1, the tape guides 35 are mounted on the first sub panel 26, which reliably reduces transmission of vibration caused by the first motor 22, the second motor 23, and the capstan motor 24, to the tape guides 35.

It should be noted that the present inventors have executed the following experiment so as to inspect the performance of the servo pattern recording device according to the present invention. In this experiment, the servo pattern Ps was recorded on the magnetic tape 300 using the above-described servo writer 1, and measurement was performed on the magnetic tape 300 so as to determine the amount of off-track of the servo pattern Ps. In this case, a PES (Positioning Error Signal: numerical value which expresses a variation in the amount of displacement, in terms of a standard deviation σ) was measured by an LTO drive, and the value obtained by the measurement was set to the amount of off-track of the servo pattern Ps. Further, when the servo pattern Ps was recorded, the amount of vibration of the magnetic head 21 was measured using an acceleration sensor. In this case, a relative value with respect to the value of a voltage (amplitude of a voltage corresponding to the amount of vibration of the magnetic head 21) outputted from the acceleration sensor in Comparative Example 1, described hereinafter, (in other words, a ratio of the value of the output voltage from the acceleration sensor to the value of the output voltage from the same in Comparative Example 1, which is assumed to be “1”) was set to the amount of vibration of the magnetic head 21. It should be noted that the tape speed (traveling speed) of the magnetic tape 300 was set to three tape speeds: 2.5 m/s, 5.0 m/s, and 10.0 m/s, and experiments carried out at the respective tape speeds were referred to as Example 1, Example 2, and Example 3, respectively.

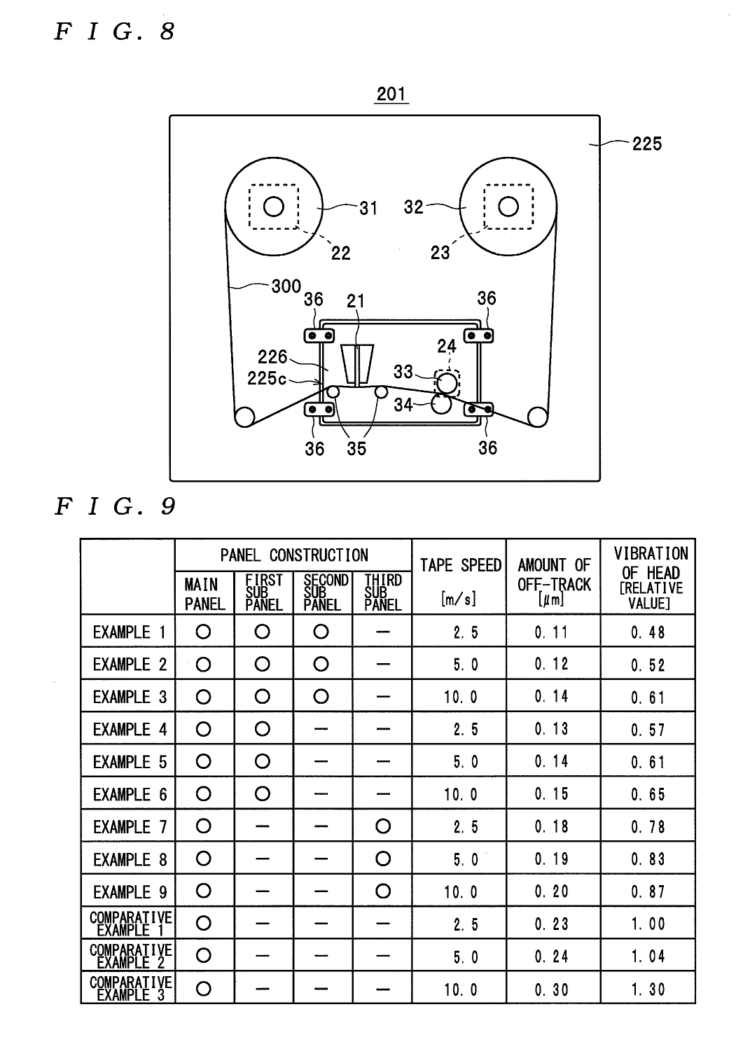

Further, the same experiments as described above were carried out using a servo writer 101 (another example of the servo pattern recording device according to the present invention) constructed by directly mounting the capstan motor 24, the capstan 33 and the pinch roller 34 on a main panel 125 formed with no second opening 25d, as shown in FIG. 7. It should be noted that component elements having the same functions as those of the component elements of the aforementioned servo writer 1 are designated by identical reference numerals and duplicate description thereof is omitted. Further, similarly to the above, the three tape speed were set, and experiments carried out at the respective tape speeds were referred to as Example 4, Example 5, and Example 6, respectively. Furthermore, as shown in FIG. 8, the same experiments as described above were carried out using a servo writer 201 (still another example of the servo pattern recording device according to the present invention) which is comprised of a main panel 225 formed with a third opening 225c larger than the first opening 25c, and a third sub panel 226 which has the magnetic head 21, the capstan motor 24, the capstan 33, the pinch roller 34, and the tape guides 35 mounted thereon and is configured to be capable of being fitted in the third opening 225c, and is constructed by connecting the panels 225 and 226 via the connecting members 36. It should be noted that third sub panel 226 was connected to the main panel 225 similarly to the servo writer 1 described hereinabove. Further, similarly to the above, the three tape speed were set, and experiments carried out at the respective tape speeds were referred to as Example 7, Example 8, and Example 9, respectively.

Further, the same experiments as described above were carried out using a servo writer (conventional servo writer) constructed by directly mounting the magnetic head 21, the first motor 22, the second motor 23, the capstan motor 24, the capstan 33, the pinch roller 34, and the tape guides 35 on a main panel formed with no first opening 25c nor the second opening 25d. It should be noted that similarly to the above, the three tape speed were set, and the experiments carried out at the respective tape speeds were referred to as Comparative Example 1, Comparative Example 2, and Comparative Example 3, respectively.

Referring to FIG. 9, it is clear from the results of the above experiments that the amount of off-track of the servo pattern Ps is the smallest when the servo writer 1 is used, the second smallest when the servo writer 101 is used, and the third smallest when the servo writer 201 is used. Further, the amount of off-track of the servo pattern Ps is smaller whichever of the servo writers 1, 101 and 201 is used than when the conventional servo writer is used. On the other hand, the amounts of vibration of the magnetic head 21 of the servo writers 1, 101 and 201 become sequentially larger in the mentioned order (in an increasing order of the above-described amount of off-track of the servo pattern Ps), and at the same time whichever of the servo writers 1, 101 and 201 is used, the amount of vibration of the magnetic head 21 is smaller than that of vibration of the magnetic head 21 of the conventional servo writer. From the above, it can be understood that if the main panel 25 on which the motors 22 and 23 are mounted as sources of vibration, the second sub panel 27 on which the capstan motor 24 is mounted as a source of vibration, and the first sub panel 26 on which the magnetic head 21 is mounted are formed separately from each other, if the main panel 125 on which the motors 22, 23 and 24 are mounted and the first sub panel 26 on which the magnetic head 21 is mounted are formed separately from each other, or if the main panel 225 on which the motors 22 and 23 are mounted and the third sub panel 226 on which the magnetic head 21 and the capstan motor 24 are mounted are formed separately from each other, with the main panel 25, 125 or 225 being connected to the sub panel 26, 27 or 226 via the connecting members 36, it is possible to reduce transmission of vibration caused by the motors 22, 23 and 24 to the magnetic head 21, and make smaller the amount of off-track of the servo pattern Ps as the transmission of vibration is made smaller. From the above, it is clear that by forming a panel on which the motors 22, 23 and 24 are mounted separately from a panel on which the magnetic head 21 is mounted, and connecting the panels to each other via the connecting members 36, the recording accuracy of the servo pattern Ps is sufficiently improved.

As described above, according to the servo writer 1, the first motor 22 and the second motor 23 are mounted on the main panel 25, and the magnetic head 21 is mounted on the first sub panel 26 which is formed separately from the main panel 25 and is connected to the main panel 25 via the connecting members 36, whereby it is possible to reliably reduce transmission of vibration of the motors 22 and 23 to the magnetic head 21. Therefore, compared with the conventional servo writer in which the motors 22 and 23 and the magnetic head 21 are mounted on the main panel 25, it is possible to sufficiently improve the recording accuracy of the servo pattern Ps.

Further, according to the servo writer 1, the first sub panel 26 is connected to the main panel 25 in a state in which the first sub panel 26 is fitted in the first opening 25c such that the front surface 26a thereof and the front surface 25a of the main panel 25 are flush with each other. As a result, since no step is formed between the main panel 25 and the first sub panel 26, it is possible to prevent a step from moving the magnetic tape 300 in the direction of the width of the tape, thereby reliably preventing the recording accuracy of the servo pattern Ps from being degraded.

Further, according to the servo writer 1, the first sub panel 26 is connected to the main panel 25 with the vibration isolators 37 interposed therebetween, whereby it is possible to more reliably reduce transmission of vibration caused by the motors 22 and 23 to the magnetic head 21. This makes it possible to further improve the recording accuracy of the servo pattern Ps.

Further, according to the servo writer 1, the tape guides 35 are mounted on the first sub panel 26, whereby it is possible to reliably reduce transmission of the vibration caused by the motors 22 and 23 to the tape guides 35. Therefore, compared with a construction in which the tape guides 35 are mounted on the main panel 25, it is possible to further improve the recording accuracy of the servo pattern Ps.

Furthermore, according to the servo writer 1, the capstan motor 24 is mounted on the second sub panel 27 which is formed separately from the main panel 25 and is connected to the main panel 25 via the connecting members 36, whereby it is possible to reliably reduce transmission of vibration of the capstan motor 24 to the magnetic head 21. Therefore, compared with a construction in which the capstan motor 24 is mounted on the main panel 25, it is possible to further improve the recording accuracy of the servo pattern Ps.

Further, according to the servo writer 1, the second sub panel 27 is connected to the main panel 25 in the state in which the second sub panel 27 is fitted in the second opening 25d such that the front surface 27a thereof and the front surface 25a of the main panel 25 are flush with each other. As a result, no step is formed between the main panel 25 and the second sub panel 27, and hence it is possible to prevent a step from moving the magnetic tape 300 in the direction of the width of the tape, thereby reliably preventing the recording accuracy of the servo pattern Ps from being degraded.

Further, according to the servo writer 1, the second sub panel 27 is connected to the main panel 25 with the vibration isolator 37 interposed therebetween, whereby it is possible to more reliably reduce transmission of the vibration caused by the capstan motor 24 to the magnetic head 21. This makes it possible to further improve the recording accuracy of the servo pattern Ps.

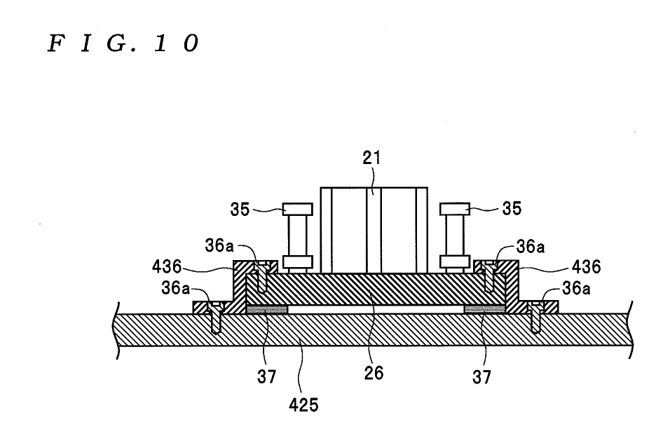

It should be noted that the present invention is not limited to the above-described configurations. For example, although the above description is given of an example in which the main panel and the sub panels are connected to each other in a state in which the sub panels (the above-described first sub panel 26, second sub panel 27 and third sub panel 226) are fitted in the respective openings (the above-described first opening 25c, second opening 25d, and third opening 225c) formed in the main panel, as shown in FIG. 10, it is also possible to employ a configuration in which the first sub panel 26 is connected to a main panel 425 via connecting members 436 in a state in which the main panel 425 formed with no opening and the first sub panel 26 are not in direct contact with each other. Further, it is also possible to employ a configuration in which the main panel 25 and the sub panels 26 and 27 are connected to each other without interposing the vibration isolators 37 between the main panel 25 and each of the sub panels 26 and 27.

What is claimed is:

1. A servo pattern recording device comprising:
a magnetic head that records a servo pattern for tracking servo on a magnetic tape;
a first motor that feeds the magnetic tape;
a second motor that takes up the magnetic tape; and
a main panel along a surface of which the magnetic tape is caused to move,
wherein the first motor and the second motor are mounted on the main panel, and
wherein the magnetic head is mounted on a first sub panel that is formed separately from the main panel and is connected to the main panel via a connecting member.

2. A servo pattern recording device according to claim 1, wherein the main panel is formed with a first opening in which the first sub panel can be fitted, and
wherein the first sub panel is connected to the main panel in a state in which the first sub panel is fitted in the first opening such that the surface of the main panel and a surface of the first sub panel are flush with each other.

3. A servo pattern recording device according to claim 1, wherein the first sub panel is connected to the main panel with a vibration isolator interposed between the first sub panel and the main panel.

4. A servo pattern recording device according to claim 1, wherein a tape guide that guides the magnetic tape to the magnetic head is mounted on the first sub panel.

5. A servo pattern recording device according to claim 1, comprising a capstan motor that controls a traveling speed of the magnetic tape,
wherein the capstan motor is mounted on a second sub panel that is formed separately from the main panel and is connected to the main panel via a connecting member.

6. A servo pattern recording device according to claim 5, wherein the main panel is formed with a second opening in which the second sub panel can be fitted, and
wherein the second sub panel is connected to the main panel in a state in which the second sub panel is fitted in the second opening such that the surface of the main panel and a surface of the second sub panel are flush with each other.

7. A servo pattern recording device according to claim 5, wherein the second sub panel is connected to the main panel with a vibration isolator interposed between the second sub panel and the main panel.
